(19) United States
(12) Patent Application Publication
(10) Pub. No.: US 2007/0014496 A1
(43) Pub. Date: Jan. 18, 2007

(54) Fluid dynamic bearing system

(75) Inventors: Martin Engesser, Donaueschingen (DE); Stefan Schwamberger, Hermsdorf (DE)

Correspondence Address: NORMAN H. ZIVIN;Cooper & Dunham LLP, 1185 Avenue of the Americas, New York, NY, 10036, US

(73) Assignee: Minebea Co., Ltd.

(21) Appl. No.: 11/484,800

(22) Filed: Jul. 11, 2006

(30) Foreign Application Priority Data
Jul. 13, 2005 (DE) 10 2005 032 631.5

(51) Int. Cl. F16C 32/06

(52) U.S. Cl. 384/107

(57) ABSTRACT

The invention relates to a fluid dynamic bearing system. It comprises a stationary part consisting of a cup-shaped housing and a bearing bush disposed therein, a moving part consisting of an arrangement of a shaft and a hub rotatably accommodated in the bearing bush and a thrust plate disposed at one end of the shaft that is accommodated in an annular disk-shaped space formed by the housing and the bearing bush. The respective surfaces opposing each other of the stationary part and the moving part are spaced apart from each other by a bearing gap filled with bearing fluid. The bearing system further comprises at least one radial bearing formed by the outer surface of the shaft and the inner surface of the bearing bush and associated hydrodynamic bearing patterns, a first axial bearing formed by a first end face of the bearing bush, an opposing end face of the hub and associated hydrodynamic bearing patterns, and a second axial bearing formed by a second end face of the bearing bush, an opposing end face of the thrust plate and associated hydrodynamic bearing patterns.

### BACKGROUND OF THE INVENTION

The invention relates to a fluid dynamic bearing system used preferably to rotatably support a small-scale spindle motor, as preferably employed for driving hard disk drives.

### PRIOR ART

The ongoing miniaturization of hard disk drives is giving rise to new problems in their design and construction, particularly with regard to the design and construction of small drive motors and suitable bearing systems. Although roller bearing systems have mainly been used to date, fluid dynamic bearing systems are becoming increasingly popular due to their small-scale construction and greater precision.

It is known to provide existing bearing systems with two radial bearings. In order to achieve the required bearing stiffness, the radial bearings have to be disposed at a sufficient axial distance from one another. However, conventional solutions in the design of fluid dynamic hard disk drive bearings and methods for their manufacture are either impossible to apply or can only be applied with difficulty in the design and construction of miniature spindle motors. The smaller the bearing systems become, and thus the distance between the two radial bearings, the lower are their load-bearing capacity and stiffness when conventional construction methods are used.

U.S. Pat. No. 5,538,347 A reveals an air bearing that comprises a rotating annular component that rotates about a stationary cylindrical component. A radial bearing is disposed between the peripheral surfaces facing each other of the two components. The end faces of the rotating component, together with two stationary disk-shaped components, each form an axial bearing. The bearing surfaces are spaced apart from each other by a bearing gap using a well-known procedure. The dynamic air pressure required in the bearing gap is generated by surface patterns that are formed on the bearing surfaces.

### SUMMARY OF THE INVENTION

The object of the invention is to create a spindle motor having a fluid dynamic bearing that has high bearing stiffness particularly in the case of a small-scale construction and more particularly when the overall height is kept low.

This object has been achieved according to the invention by the characteristics outlined in claim 1.

Preferred embodiments and other beneficial characteristics of the invention are cited in the subordinate claims.

The fluid dynamic bearing system according to the invention comprises a stationary part consisting of a cup-shaped housing and a bearing bush disposed within the housing, a moving part consisting of an arrangement of a shaft and a hub that is rotatably accommodated within the bearing bush, and a thrust plate (5) disposed at one end of the shaft that is accommodated in an annular disk-shaped space formed by the housing and the bearing bush. The respective surfaces opposing each other of the stationary part and the moving part are spaced apart from each other by a bearing gap filled with bearing fluid. The bearing system further comprises a radial bearing formed by the outer surface of the shaft and the inner surface of the bearing bush as well as associated hydrodynamic bearing patterns, a first axial bearing formed by a first end face of the bearing bush, an opposing end face of the hub and associated hydrodynamic bearing patterns, and a second axial bearing formed by a second end face of the bearing bush, an opposing end face of the thrust plate and associated hydrodynamic bearing patterns.

In a first embodiment of the invention the bearing patterns of the radial bearing are disposed on the outside circumference of the shaft and the bearing patterns of the axial bearings on the two end faces of the bearing bush.

In a preferred embodiment of the invention all the bearing patterns, i.e. the bearing patterns of the radial bearing and those of the axial bearings, are disposed solely on the bearing bush. This means that, with regard to the bearing patterns, only the bearing bush need be machined, thus simplifying the manufacture of the bearing. It is advantageous if the bearing bush is made as a sintered part, using either sintered metal or sintered ceramics. Plastics/metal sintered materials could also be used. The advantages provided by sintering include cost-effective manufacture as well as the possibility of integrating the bearing patterns at an early stage into the sintered part. This eliminates the need for any finishing work and the later application of bearing patterns to the surfaces of the bearing bush.

An annular space, connected to the bearing gap and tapered in the direction of the bearing gap, is disposed in the region of the open end of the bearing gap between a surface of the inside circumference of the hub and an opposing surface of the outside circumference of the housing, the annular space being at least partly filled with bearing fluid. This space defines the bearing gap towards the outside and in a first function forms a capillary seal to seal the bearing gap and in a second function, it forms a reservoir for the bearing fluid.

For the purpose of improving the circulation of bearing fluid between the reservoir and the axial bearing region, provision can further be made for the bearing sleeve to have at least one longitudinal channel at its outside diameter.

An additional third axial bearing or a substitute for the first axial bearing can be provided by an end face of the thrust plate and an opposing face of the housing base as well as the associated hydrodynamic bearing patterns.

In a preferred embodiment, the housing takes the form of a one-piece, cup-shaped part such as a deep-drawn part. However, the housing can also be made in two parts and consist of a cylindrical sleeve part and a disk-shaped base part, the parts being welded gastight together, for example.

The bearing system according to the invention is preferably employed to rotatably support a spindle motor, the spindle motor having a baseplate or a flange having an opening to receive the housing of the bearing system, and an electromagnetic drive unit for driving the moving part of the bearing system.

The spindle motor can preferably be used for driving the storage disks of a hard disk drive, the hub being used as a carrier for the at least one storage disk of the hard disk drive.

Integrating the functions of the components means that the bearing system according to the invention is made up of only a few components. These components can be made using conventional manufacturing processes. Since the required tilt resistance is not achieved through radial bearings having a large axial spacing, but rather primarily through the two axial bearings, the required overall height can be kept low. This makes for high axial stiffness. The radial stiffness that is still necessary is provided by the radial bearing.

The invention is explained in more detail below on the basis of an embodiment with reference to the drawings. Further characteristics, advantages and possible applications of the invention can be derived from the drawings and their description.

### BRIEF DESCRIPTION OF THE DRAWINGS

The drawings show:

FIG. 1: a section through a spindle motor according to the invention having a fluid dynamic bearing system;

FIG. 2: a top view of the bearing sleeve of the bearing system;

FIG. 3: a section through the bearing sleeve of FIG. 2;

FIG. 4: a bottom view of the bearing sleeve of FIG. 2;

FIG. 5: a perspective view of the bearing sleeve of FIG. 2;

FIG. 6: a top view of an alternative embodiment of the bearing sleeve of the bearing system;

FIG. 7: a section through the bearing sleeve of FIG. 6;

FIG. 8: a bottom view of the bearing sleeve of FIG. 6;

FIG. 9: a perspective view of the bearing sleeve of FIG. 6;

FIG. 10: a section through a spindle motor having a second embodiment of the fluid bearing according to the invention;

FIG. 11: a section through a spindle motor having a third embodiment of the fluid bearing according to the invention.

### DESCRIPTION OF PREFERRED EMBODIMENTS OF THE INVENTION

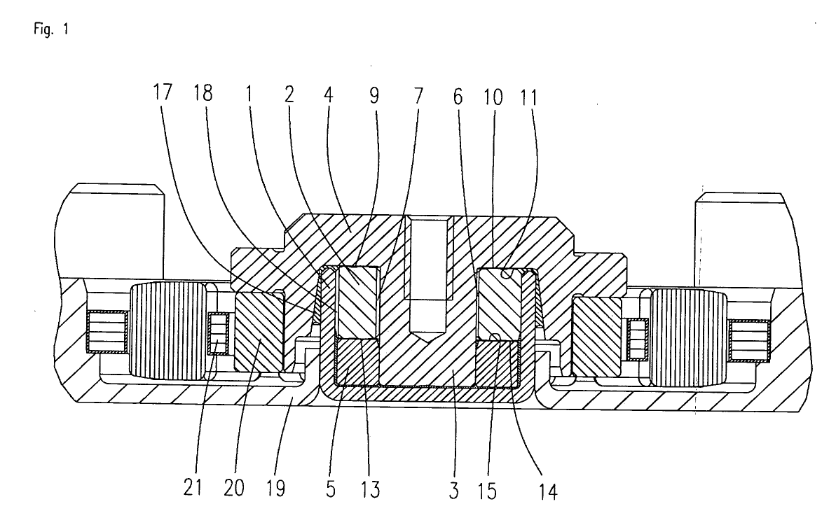

FIG. 1 shows the basic construction of a spindle motor having a first embodiment of the fluid dynamic bearing system according to the invention. The spindle motor is characterized by its simple design and flat construction.

The spindle motor comprises a baseplate 19 or a base flange that is designed, for example, as a deep-drawn part and has an opening in which a substantially cup-shaped housing 1 is inserted, the cup-shaped housing possibly also being a deep-drawn part. A cylindrical bearing bush 2 is disposed in the region of the opening at the inside diameter of the housing 1, the bearing bush together with the housing 1 and the flange 19 forming the stationary part of the bearing system. The bearing bush 2 is pressfitted, for example, into the housing 1. A shaft 3 is rotatably accommodated in a concentric bore in the bearing bush 2, the shaft 3 being preferably integrally formed with a hub 4 of the spindle motor. It is of course clear that the shaft 3 and the hub 4 could also be formed from two separate parts that are connected together using, for example, a pressfit. The length of the shaft 3 is longer than that of the bearing bush 2 so that one end of the shaft protrudes from the bearing bush. An annular thrust plate 5 that is firmly fixed to the shaft 3 is disposed at the protruding end of the shaft. The thrust plate 5, the shaft 3 and the hub 4 form the moving part of the bearing system. The thrust plate 5 is disposed in an annular disk-shaped cavity within the housing formed by the housing 1, the shaft 3 and the bearing bush 2. The housing 1 and the bearing bush 2 or the shaft 3 and the thrust plate 5 respectively are fixedly connected to each other. The respective opposing surfaces of the bearing bush 2 and the shaft 3 or the housing 1, the thrust plate 5 and the bearing bush 2 respectively are spaced apart from one another by a bearing gap 6 filled with a bearing fluid, such as a bearing oil. The axial bearing gap has a width, for example, of 5 to 20 micrometers, the radial bearing gap typically has a width of 2 to 6 micrometers.

The hydrodynamic bearing system comprises a radial bearing 7 that is formed by the outer surface of the shaft 3 and the inner surface of the bearing bush 2 opposing the outer surface as well as associated hydrodynamic bearing patterns 8 that may be disposed on the surface of the shaft 3 and/or the inner surface of the bearing bush 2.

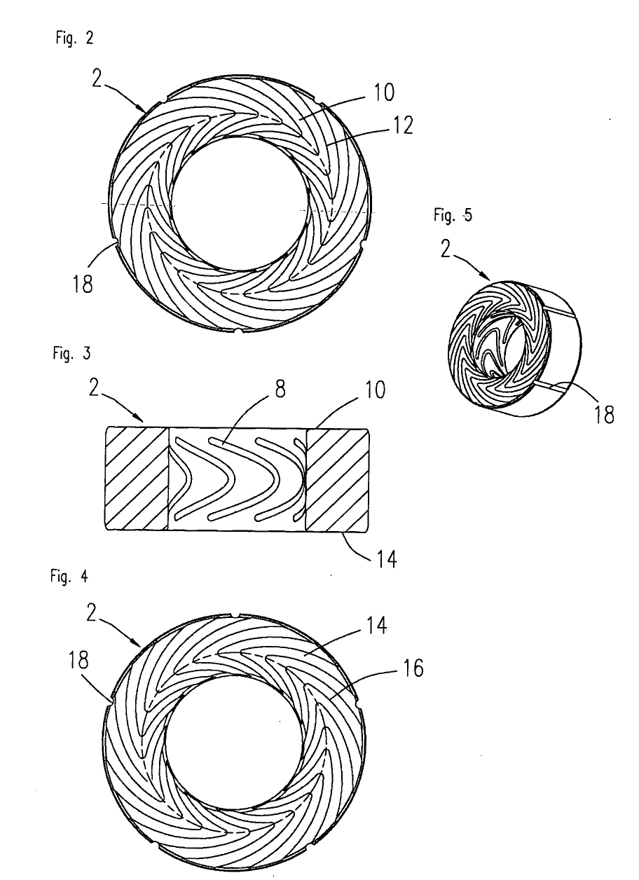

In FIG. 3, for example, it is possible to see the radial bearing patterns 8 that are provided on the inner surface of the bearing bush 2.

The bearing system further comprises a first axial bearing 9 that is formed by a first end face 10 of the bearing bush 2 and an opposing end face 11 of the hub 4 as well as associated hydrodynamic bearing patterns 12 that are preferably disposed at the upper end face 10 of the bearing bush 2 as shown, for example, in FIG. 2. The bearing patterns could of course also be disposed at the end face 11 of the hub 4, although for manufacturing reasons this is less interesting.

A second axial bearing 13 is formed by the second end face 14 of the bearing bush 2, an opposing end face 15 of the thrust plate 5 and associated hydrodynamic bearing patterns 16 that are preferably disposed on the lower end face 14 of the bearing bush 2 as shown, for example, in FIG. 4. The bearing patterns 16 can of course be alternatively disposed on the end face of the thrust plate 5.

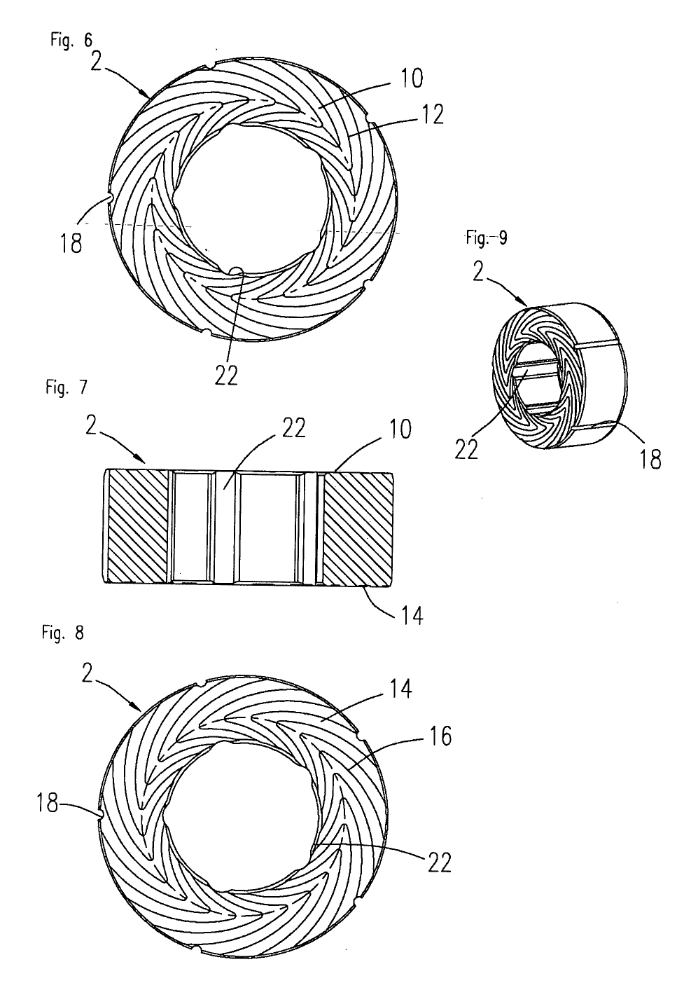

FIG. 5 shows an overall perspective view of the bearing bush 2 illustrating the radial bearing patterns and the axial bearing patterns 8, 12 on the surfaces. It is preferable if all the bearing patterns, i.e. those of the radial and those of the axial bearings, are disposed solely on the bearing bush 2. This means that only the bearing bush 2 need be machined accordingly, where the bearing bush can be manufactured advantageously as a sintered part in which the bearing patterns can be integrated at an early stage into the blank.

The bearing gap 6 ends in the region of the first axial bearing 9 and is defined by a space 17 that is formed between the inside circumference of the hub 4 and the outside circumference of the housing 1. Here, the inside diameter of the hub 4 varies somewhat in the region of this space 17 so that the annular space tapers, narrowing in the direction of the bearing gap or of the axial bearing 9 and merges into the bearing gap 6. The space 17 acts on the one hand as a capillary seal for the bearing gap 6 and on the other hand as a supply volume, i.e. a reservoir, for the bearing fluid. The space 17 is consequently also partly filled with bearing fluid.

For the improved circulation of the bearing fluid and the supply of the lower axial bearing 13, provision is made for one or more axial channels 18 to be disposed at the outside circumference of the bearing sleeve 2, the channels acting as overflow channels for the bearing fluid. These channels 18 can be seen in FIGS. 2, 4 and 5.

The electromagnetic drive system of the spindle motor is disposed outside the bearing system at the outside circumference of the hub 4 or about the hub 4. The drive system comprises permanent magnets 20 that are disposed at the outside circumference of the hub 4 as well as a stator arrangement 21 that is disposed opposite the magnets 20 and generates an alternating electromagnetic field which sets the hub 4 and thus the rotating part of the spindle motor into rotation. Storage disks (not illustrated) of a hard disk drive can be mounted on the hub 4, more precisely on the upper shoulder of the hub, the storage disks being then accordingly driven in rotation by the spindle motor.

It can be seen from FIGS. 2 to 5 that the bearing patterns 8 of the radial bearing 7 are sinus-shaped or parabolic in form and exert a corresponding pumping action on the bearing fluid found in the bearing gap 6 when the bearing is in operation. The bearing patterns 12 or 16 of the axial bearing are given a herringbone shape, for example, and again generate a pressure-generating pumping action on the bearing fluid that gives the bearing system its load-carrying capacity.

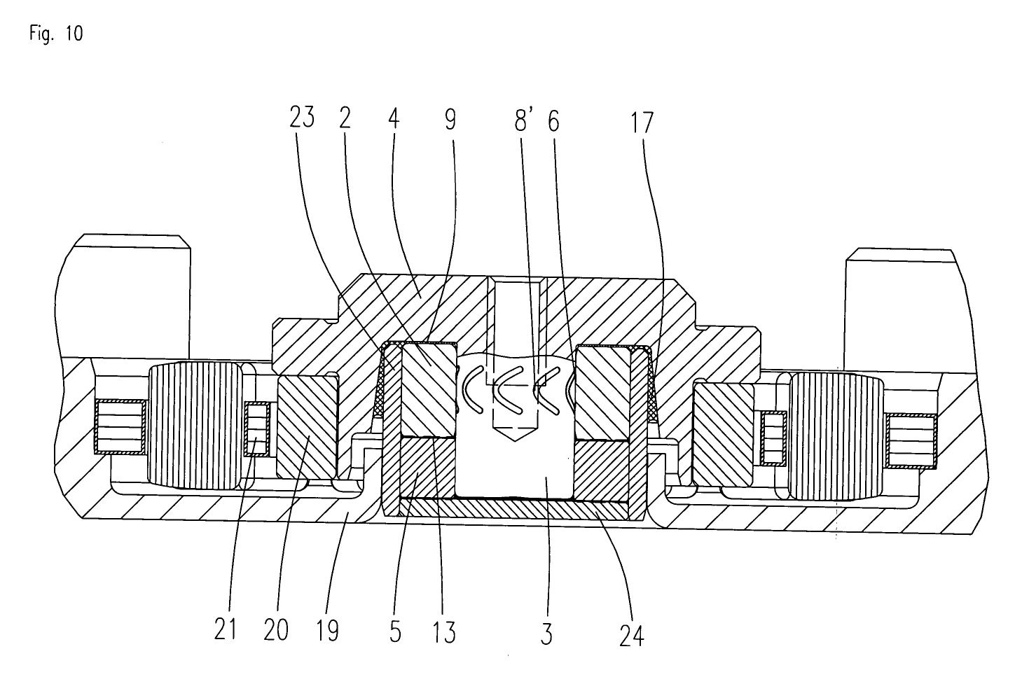

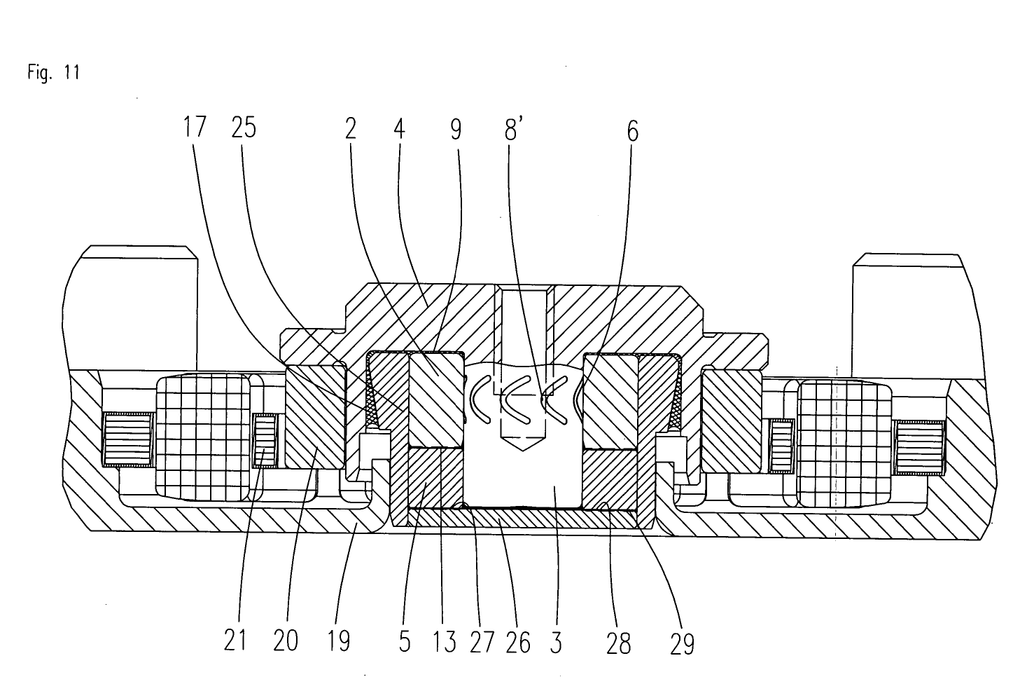

Another possible embodiment of a bearing bush 2 is shown in FIGS. 6 to 9. The end faces 10 or 14 having the axial bearing patterns 12 or 16 remain unchanged in form compared to FIGS. 2 to 5.

The bearing patterns 22 of the radial bearing, however, differ from the first embodiment of the bearing bush and, in the illustrated embodiment, comprise 5 asymmetric, circular arc-shaped sections that are each interrupted by five axial channels. On rotation of the bearing system, this design of the inner surface of the bearing bush exerts pressure on the bearing fluid giving the radial bearing its load-carrying capacity. When conventional machining processes such as drilling and milling are used, it is very expensive to produce this kind of radial bearing pattern 12. Manufacturing the bearing bush 2 as a complete sintered part, however, makes it very simple to realize these kinds of bearing patterns 22 using, for example, a stamping process, thus making them a useful alternative to bearing patterns 8.

FIG. 10 shows a spindle motor having a slightly modified embodiment of the bearing system according to the invention than that of FIG. 1. In FIG. 10 identical components to those in FIG. 1 are given the same reference numbers. For a description of these components, reference is made to the description of the drawings of FIG. 1.

An initial difference between the bearing system of FIG. 10 compared to that of FIG. 1 is that, instead of being on the inside diameter of the bearing bush 2, the bearing patterns 8′ of the radial bearing are now provided on the outside diameter of the shaft 3. The two axial bearings 9 or 13, however, are the same as in FIG. 1.

Another difference in the bearing system in FIG. 10 is that the housing that receives the bearing system is now made in two parts and consists of a cylindrical sleeve part 23 which is closed at one end by a plate-shaped base part 24. The base part 24 is welded gastight to the sleeve part 23. The two-part design of the housing 23, 34 has the advantage that the bearing system can be more easily mounted, the thrust plate 5 in particular being easier to mount, allowing the bearing to then be completed by closing the housing with the base part 24.

FIG. 11 shows a section through a spindle motor having a third embodiment of the fluid bearing system. With reference to FIG. 1 and the description of the figures, the same components appearing in FIG. 11 are given the same reference numbers.

In contrast to FIG. 1, no axial bearing is provided between the opposing end faces of the bearing sleeve 2 and the hub 4. Instead, as in FIG. 1, an axial bearing 13 is provided between the opposing end faces of the bearing sleeve 2 and the thrust plate 5, as well as a further axial bearing between the opposing faces of the thrust plate 5 and the base part 26 of the housing, which in this case acts as a counter bearing. Again in FIG. 11 as in FIG. 10, the housing is formed in two parts and consists of a sleeve part 25 and a base part 26 that closes the sleeve at one end. Compared to FIG. 10, however, the sleeve part 25 has a thickening or bulge in its upper region where the bearing sleeve 2 is fixed, the width of this bulge increasing towards the rim of the sleeve part 25. The outside circumference of this bulge adjoins the space 17 that acts as a reservoir for the bearing fluid. The bulge thickening towards the rim of the sleeve causes the space 17 to taper in the direction of the bearing gap 6, allowing the hub 4 to have an unchanged inside diameter compared to the hub in FIG. 1. This makes it easier to manufacture the hub 4 since only the sleeve part need have a respective bulge or thickening. The bearing patterns for the axial bearing 27 can be provided either on the surface of the thrust plate 5 or on the opposing surface of the base part 26.

### IDENTIFICATION REFERENCE LIST

1 Housing
2 Bearing bush
3 Shaft
4 Hub
5 Thrust plate
6 Bearing gap
7 Radial bearing
8 Bearing patterns 8′
9 Axial bearing
10 End face (bush)
11 End face (hub)
12 Bearing patterns
13 Axial bearing
14 End face (bush)
15 End face (thrust plate)
16 Bearing patterns
17 Space
18 Channel
19 Baseplate
20 Magnet
21 Stator arrangement
22 Bearing patterns
23 Sleeve part
24 Base part
25 Sleeve part
26 Base part
27 Axial bearing
28 Surface (base)
29 End face (thrust plate)

1. A fluid dynamic bearing system comprising:
a stationary part consisting of a cup-shaped housing (1) and a bearing bush (2) disposed therein,
a moving part consisting of an arrangement of a shaft (3) and a hub (4) rotatably accommodated in the bearing bush (2) and a thrust plate (5) disposed at one end of the shaft (3) that is accommodated in an annular disk-shaped space formed by the housing and the bearing bush,
the respective surfaces opposing each other of the stationary part and the moving part being spaced apart from each other by a bearing gap (6) filled with bearing fluid;
at least one radial bearing (7) formed by the outer surface of the shaft (3) and the inner surface of the bearing bush (2) and associated hydrodynamic bearing patterns (8);
a first axial bearing (9) formed by a first end face (10) of the bearing bush (2), an opposing end face (11) of the hub (4) and associated hydrodynamic bearing patterns (12), and
a second axial bearing (13) formed by a second end face (14) of the bearing bush, an opposing end face (15) of the thrust plate (5) and associated hydrodynamic bearing patterns (16).

2. A bearing system according to claim 1, characterized in that the bearing patterns (8′) of the radial bearing are disposed on the outside circumference of the shaft (3) and the bearing patterns (12, 16) of the axial bearings on the end faces (10; 14) of the bearing bush (2).

3. A bearing system according to claim 1, characterized in that the bearing patterns (8, 12, 16) of the radial and of the axial bearings are disposed solely on the bearing bush (2).

4. A bearing system according to claim 1, characterized in that the bearing bush (2) is a sintered part.

5. A bearing system according to claim 1, characterized in that an annular space (17), connected to the bearing gap (6) and tapered in the direction of the bearing gap, is disposed between a surface of the inside circumference of the hub (4) and an opposing surface of the outside circumference of the housing (1), the annular space being at least partly filled with bearing fluid.

6. A bearing system according to claim 5, characterized in that the space (17) defines the bearing gap (6) towards the outside and forms a capillary seal to seal the bearing gap.

7. A bearing system according to claim 5, characterized in that the space (17) forms a reservoir for the bearing fluid.

8. A bearing system according to claim 1, characterized in that the bearing bush (2) has at least one longitudinal channel (18) flowing with bearing fluid at its outside diameter.

9. A bearing system according to claim 1, characterized in that a third axial bearing (27), in addition to the first and second axial bearings (9; 13) or as a substitute for the first axial bearing (9), is formed by an end face (29) of the thrust plate (5) and an opposing surface (28) of the housing base (26) and associated hydrodynamic bearing patterns.

10. A bearing system according to claim 1, characterized in that the housing (1) is made in two parts and consists of a cylindrical sleeve part (23; 25) and a disk-shaped base part (24; 26).

11. A spindle motor having a bearing system according to, claim 1, further comprising a baseplate (19) having an opening to receive the housing (1) of the bearing system, and an electromagnetic drive unit (20, 21) for driving the moving part of the bearing system.

12. A spindle motor according to claim 11, characterized in that it forms a part of a hard disk drive.

13. A spindle motor according to claim 11, characterized in that the hub (4) is designed as a carrier for a storage disk of the hard disk drive.
